(19) United States
(12) Patent Application Publication
(10) Pub. No.: US 2009/0186780 A1
(43) Pub. Date: Jul. 23, 2009

(54) Biochip

(76) Inventors: June-Young Lee, Anyang-si (KR); Dong-Ho Lee, Seongnam-si (KR); Nam Huh, Seoul (KR)

Correspondence Address: F. CHAU & ASSOCIATES, LLC, 130 WOODBURY ROAD, WOODBURY, NY, 11797, US

(21) Appl. No.: 12/349,299

(22) Filed: Jan. 6, 2009

(30) Foreign Application Priority Data
Jan. 23, 2008 (KR) 10-2008-0007246

(51) Int. Cl. C40B 60/12

(52) U.S. Cl. 506/39

(57) ABSTRACT

A biochip for qualitatively analyzing a biological sample using probes includes a probe cell array comprising a plurality of probe cells capable of coupling with biomolecules of a biological sample, an optical sensor for detecting optical signals from probe cells selectively coupling with the biomolecules of the biological sample and converting the optical signals to digital electrical signals, and a memory cell array for storing the digital electrical signals.

### CROSS-REFERENCE TO RELATED APPLICATION

This application claims priority from Korean Patent Application No. 10-2008-0007246 filed on Jan. 23, 2008 in the Korean Intellectual Property Office, the contents of which are herein incorporated by reference in their entirety.

### BACKGROUND OF THE INVENTION

1. Field of the Invention

The present disclosure is directed to a biochip, and more particularly, to a biochip for qualitatively analyzing a biological sample using probes.

2. Description of the Related Art

A biochip is a representative microarray that qualitatively analyzes a biological sample by monitoring the reaction of the biological sample with known probes immobilized on a substrate. Several different probes can be immobilized on respective cells in a single biochip to obtain various data.

Biochip sizes are being scaled down to several tens of micrometers as qualitative information on a biological sample sought to be analyzed is diversified. Therefore, there is an increasing need to develop a method of rapidly and stably detecting the occurrence of target-probe hybridization in a biochip.

### SUMMARY OF THE INVENTION

Embodiments of the present invention provide a biochip capable of more rapidly and stably detecting the occurrence of target-probe hybridization.

The above and other features of embodiments of the present invention will be described in or be apparent from the following description of exemplary embodiments.

According to an aspect of the present invention, there is provided a biochip including a probe cell array comprising a plurality of probe cells capable of coupling with biomolecules of a biological sample, an optical sensor adapted to detecting optical signals from probe cells selectively coupling with the biomolecules of the biological sample and converting the optical signals to digital electrical signals, and a memory cell array adapted to storing the digital electrical signals.

According to another aspect of the present invention, there is provided a biochip including a probe cell array comprising a plurality of probe cells capable of coupling with biomolecules of a biological sample and detecting electrical signals from probe cells selectively coupling with the biomolecules of the biological sample, and a memory cell array adapted to storing the electrical signals.

According to another aspect of the present invention, there is provided biochip including a probe cell array comprising a plurality of probe cells capable of coupling with biomolecules of a biological sample, and an optical sensor adapted to detecting optical signals from probe cells selectively coupling with the biomolecules of the biological sample and converting the optical signals to digital electrical signals, wherein the optical sensor comprises an optical sensor pixel array comprising a plurality of optical sensor pixels converting the optical signals to analog electrical signals, and an analog-to-digital converter converting the analog electrical signals to the digital electrical signals.

### BRIEF DESCRIPTION OF THE DRAWINGS

FIG. 1 is a schematic view illustrating a biochip according to an embodiment of the present invention.

FIG. 2 is a view illustrating probe cells and optical sensor pixels according to an embodiment of the present invention.

FIG. 3 is a block diagram illustrating an optical sensor of the biochip of FIG. 1.

FIG. 4 is a schematic view illustrating a biochip according to another embodiment of the present invention.

FIG. 5 is a schematic view illustrating a biochip according to still another embodiment of the present invention.

FIG. 6 is a layout illustrating a probe cell array of the biochip of FIG. 5.

FIG. 7 is a front view illustrating a probe cell of the probe cell array of FIG. 6.

FIG. 8 is a perspective view illustrating a semiconductor nanostructure of the probe cell of FIG. 7.

FIG. 9 is a sectional view taken along a line IX-IX′ of FIG. 7.

### DETAILED DESCRIPTION OF EXEMPLARY EMBODIMENTS

Features of embodiments of the present invention and methods of accomplishing the same may be understood more readily by reference to the following detailed description of exemplary embodiments and the accompanying drawings. Embodiments of the present invention may, however, be embodied in many different forms and should not be construed as being limited to the embodiments set forth herein. Like numbers refer to like elements throughout.

Biochips according to embodiments of the present invention analyze biomolecules contained in biological samples and are used in gene expression profiling; genotyping through detection of mutation or polymorphism such as Single-Nucleotide Polymorphism (SNP), protein or peptide assays; potential drug screening; development and preparation of novel drugs, etc. Biochips employ appropriate probes according to the kind of biological sample to be analyzed. Examples of probes include a DNA probe, a protein probe such as an antibody/antigen or a bacteriorhodopsin, a bacterial probe, a neuron probe, and so on. A biochip may be referred to as a DNA chip, a protein chip, a cellular chip, a neuron chip, and so on according to the kind of probe used.

Biochips according to embodiments of the present invention may comprise oligomer probes. As used herein, the term “oligomer” is a low-molecular weight polymer molecule including two or more covalently bound monomers. Oligomers have a molecular weight of about 1,000 or less. In detail, the oligomer may include about 2-500 monomers, 5-300 monomers, and 5-100 monomers but embodiments of the present invention are not limited thereto.

The monomers may be nucleosides, nucleotides, amino acids, peptides, etc., according to the type of probes. As used herein, the terms “nucleosides” and “nucleotides” include not only known purine and pyrimidine bases, but also methylated purines or pyrimidines, acylated purines or pyrimidines, etc. Furthermore, the “nucleosides” and “nucleotides” include not only (deoxy)ribose, but also a modified sugar which contains a substitution of a halogen atom or an aliphatic group for at least one hydroxyl group or is functionalized with an ether, amine, or the like. As used herein, the term “amino acids” is intended to refer to not only naturally occurring, L-, D-, and nonchiral amino acids, but also modified amino acids, amino acid analogs, etc. As used herein, the term “peptides” refers to compounds produced by an amide bond between the carboxyl group of one amino acid and the amino group of another amino acid.

Unless otherwise specified in the following exemplary embodiments, the term “probe” is a DNA probe, which is an oligomer probe including about 5-30 covalently bound monomers. However, embodiments of the present invention are not limited to the probes listed above and a variety of probes may used.

In the following description, the term “functional groups” are groups that can be used as starting points for organic synthesis. That is, the functional groups are groups capable of coupling with, e.g., covalently or non-covalently binding with, the previously synthesized oligomer probes or the monomers (e.g., nucleosides, nucleotides, amino acids, or peptides) for in-situ synthesis of the oligomer probes. The functional groups are not limited to any particular functional groups, provided that they can be coupled to the oligomer probes or the monomers for in-situ synthesis of the oligomer probes. Examples of the functional groups include hydroxyl groups, aldehyde groups, carboxyl groups, amino groups, amide groups, thiol groups, halo groups, and sulfonate groups.

A biochip according to an embodiment of the present invention will now be described more fully with reference to the accompanying drawings, in which exemplary embodiments of the invention are shown.

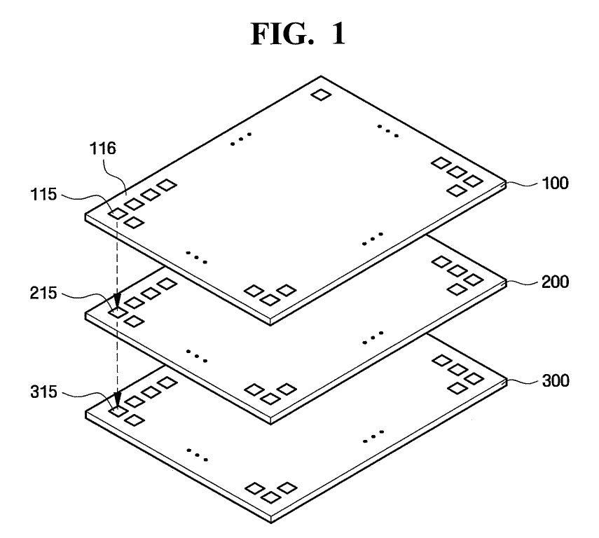

FIG. 1 is a schematic view illustrating a biochip according to an embodiment of the present invention.

Referring to FIG. 1, a biochip according to an embodiment of the present invention includes a probe cell array 100, an optical sensor 200, and a memory cell array 300. The probe cell array 100, the optical sensor 200, and the memory cell array 300 may be sequentially stacked, and in particular, they may be formed on respective different substrates and sequentially stacked.

In detail, the probe cell array 100, the optical sensor 200, and the memory cell array 300 may be independently formed on respective substrates, followed by packaging to complete a biochip. For example, the probe cell array 100, the optical sensor 200, and the memory cell array 300 may be formed by respective different processes and then packaged into a single biochip by a multi-stack package process commonly used in a semiconductor fabrication method.

When a biochip is manufactured by the above-described method, the yield of biochips can be increased, as compared with the formation of a probe cell array, an optical sensor, and a memory cell array on a single substrate. That is, in the case of manufacturing a biochip including a probe cell array, an optical sensor, and a memory cell array, even when some components are defective, packaging can be carried out in such a manner that the defective components are replaced with new components, thereby resulting in an increased production yield.

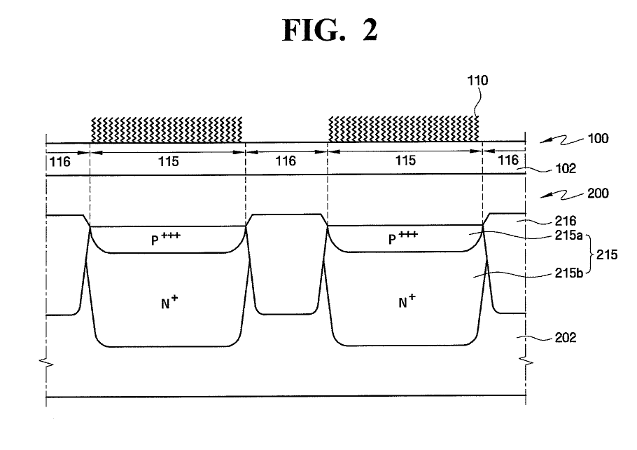

FIG. 2 is a view illustrating probe cells and optical sensor pixels according to an embodiment of the present invention.

Referring to FIGS. 1 and 2, the probe cell array 100 is formed on a first substrate 102 and includes a plurality of probe cells 115 capable of coupling with biomolecules of a biological sample. In detail, the probe cell array 100 includes the plurality of probe cells 115 coupled with the probes 110, and probe cell isolation regions 116 in which the probes 110 are not coupled.

The probes 110 of different sequences may be immobilized in the probe cells 115 disposed on the first substrate 102 such that probes having the same sequence are coupled to each one of the probe cells 115. The probe cells 115 are isolated by the probe cell isolation regions 116. Thus, the probe cells 115 may be surrounded and independently isolated by the probe cell isolation regions 116, and the probe cell isolation regions 116 may be connected to each other. The probe cells 115 may also be arranged in a matrix format.

Biomolecules of a biological sample can be detected by hybridization reactions with the probes 110 having complementary sequences. For example, biomolecules labeled with a fluorescent material are hybridized with probes and an optical signal emitted from a surface of a biochip is then detected to identify biomolecules in a biological sample.

The optical sensor 200 is disposed on a second substrate 202. The optical sensor 200 serves to detect an optical signal emitted from the probe cells 115 selectively coupling with biomolecules of a biological sample and to convert the optical signal into a digital electrical signal.

For the optical sensor 200, various optical sensors such as charge coupled devices (CCDs) or CMOS image sensors (CISs) may be used. In particular, CISs can be easily operated in various scanning modes and be manufactured in small sizes owing to signal processing circuits integrated on a single chip. Moreover, CISs can be manufactured at low cost due to compatibility with CMOS technology and can be applied to products with limited battery capacity owing to very low power consumption. In this regard, optical sensors according to the present invention will be described hereinafter in terms of CISs, but are not limited thereto. It will be understood by one of ordinary skilled in the art that other optical sensors such as CCDs can also be used as optical sensors according to other embodiments of the present invention.

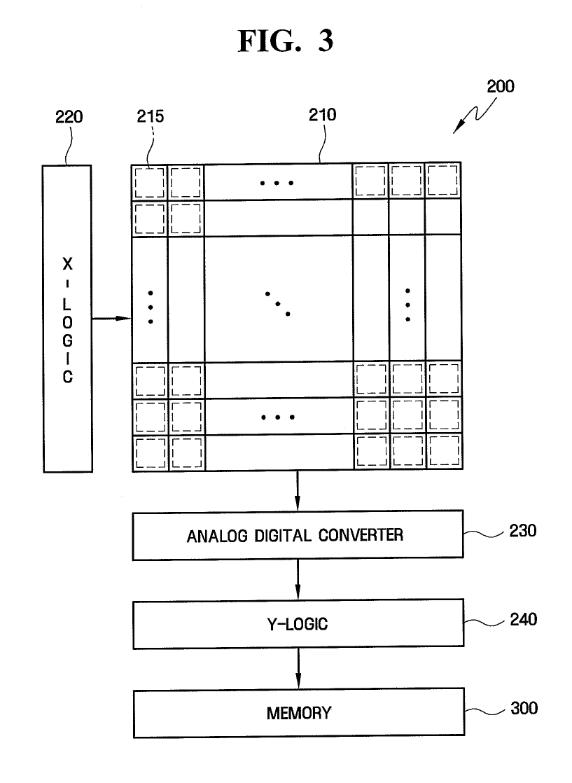

FIG. 3 is a block diagram illustrating an optical sensor of the biochip of FIG. 1.

Referring to FIG. 3, as well as FIGS. 1 and 2, the optical sensor 200 includes an optical sensor pixel array 210 disposed to correspond to the probe cell array 100, an X-logic 220, a Y-logic 240, and an analog-to-digital converter (ADC) 230.

The optical sensor pixel array 210 is disposed to correspond to the probe cell array 100, and includes a two-dimensional array of optical sensor pixels 215. The optical sensor pixels 215 are disposed below corresponding probe cells 115, and serve to detect optical signals from the probe cells 115 and to convert the optical signals into analog electrical signals.

The optical sensor pixel array 210 of the optical sensor 200 is disposed to correspond to the probe cell array 100, and the optical sensor pixels 215 of the optical sensor pixel array 210 are isolated by device isolation regions 216. In detail, the probe cells 115 may be disposed above the optical sensor pixels 215, and the probe cell isolation regions 116 may be disposed above the device isolation regions 216.

The optical sensor pixels 215 include N+ type photodiodes 215b and P+++ type pinning layers 215a. Charges may accumulate in the photodiodes 215b corresponding to optical signals emitted from fluorescent materials labeling biomolecules coupled to the probe cells 115 disposed above the photodiodes 215b. The pinning layers 215a reduce electron-hole pairs (EHPs) which may be thermally generated in the second substrate 202, thereby preventing dark current. That is, among EHPs thermally generated by dangling bonds on a surface of the second substrate 202, positive charges may be diffused to a grounded substrate via the P+++ type pinning layers 215a, and negative charges may be recombined with positive charges during diffusion into the pinning layers 215a cancelled out.

According to an embodiment of the present invention, the probe cell array 100 and the optical sensor 200 are formed in a single biochip, and the optical sensor pixels 215 are disposed below corresponding probe cells 115, thereby enabling more efficient detection of optical signals. Moreover, optical signals emitted from the probe cells 115 can be detected by corresponding optical sensor pixels 215, and thus, it is possible to detect biomolecule-probe hybridization by one-shot irradiation from an optical source of a fluorescence scanner. That is, it is possible to rapidly and accurately detect biomolecule-probe hybridization, relative to biochips in which the detection of biomolecule-probe hybridization involves detecting the optical intensity of each probe cell or several probe cells by a confocal microscope or a CCD camera.

The optical sensor pixel array 210 may be driven using several driving signals such as an optical sensor selection signal, a reset signal, and a charge transfer signal, which is received from the X-logic 220. The analog electrical signals may be transferred to the analog-to-digital converter 230.

The X-logic 220 supplies driving signals for operating the optical sensor pixels 215 to the optical sensor pixel array 210. In a case where the optical sensor pixels 215 are arranged in a matrix format in the optical sensor pixel array 210, driving signals may be supplied in a row-wise manner.

The analog-to-digital converter 230 converts the analog electrical signals from the optical sensor pixels 215 into digital electrical signals. The digital electrical signals may be supplied to the Y-logic 240.

Although FIG. 3 illustrates that the analog-to-digital converter 230 is separately disposed outside the optical sensor pixel array 210, analog-to-digital converters may be disposed in parallel to corresponding optical sensor pixels. In this case, the analog-to-digital converts can operate rapidly, and analog noise can be decreased.

The Y-logic 240 latches the digital electrical signals, and sequentially supplies the latched signals to memory cell array 300 based on the column decoding results of the latched signals.

Although not shown, a correlated double sampler may be interposed between the optical sensor pixel array 200 and the analog-to-digital converter 230. The correlated double sampler receives and holds analog electrical signals from the optical sensor pixel array 200, and performs the sampling of the analog electrical signals. That is, the correlated double sampler performs double sampling of a predetermined reference voltage level (noise level) and a voltage level (signal level) of an analog electrical signal, and outputs a difference level between the noise level and the signal level. Therefore, the optical sensor 200 can detect optical signals more accurately, thereby resulting in conversion of the optical signals into more reliable digital electrical signals.

Although not shown, a lens for focusing light may be disposed above the optical sensor pixels 215 of the optical sensor 200. Therefore, optical signals from the probe cells 115 can be more efficiently supplied to the photodiodes 215b.

The memory cell array 300 is formed on a third substrate, and stores the digital electrical signals from the optical sensor 200. The memory cell array 300 may be a nonvolatile memory cell array, such as a flash memory cell array which can hold stored digital electrical signals even when power is not supplied, but embodiments of the present invention are not limited thereto. According to other embodiments of the present invention, the memory cell array 300 may be a volatile memory cell array.

The memory cell array 300 stores digital electrical signals generated as a result of biomolecule-probe hybridization occurring in the probe cell array 100. Memory cells 315 are disposed to correspond to the probe cells 115 and the optical sensor pixels 215, and can store digital electrical signals generated as a result of biomolecule-probe hybridization in the probe cells 115. Although FIG. 1 illustrates that the probe cells 115, the optical sensor pixels 215, and the memory cells 315 are disposed in one-to-one correspondence, the results of biomolecule-probe hybridization occurring in several probe cells may also be stored in each memory cell.

Therefore, according to an embodiment of the present invention, it is not necessary to use a fluorescence scanner or the like to detect biomolecule-probe hybridization in the probe cell array 100. That is, since optical signals generated according to biomolecule-probe hybridization occurring in the probe cell array 100 are stored as digital electrical signals in the memory cell array 300, there is no need to perform scanning using a fluorescence scanner or the like for detection of biomolecule-probe hybridization.

Moreover, since detection of biomolecule-probe hybridization and storage of detection results are performed in a single chip, it is possible to more efficiently detect biomolecules in a biological sample and to analyze the detection results.

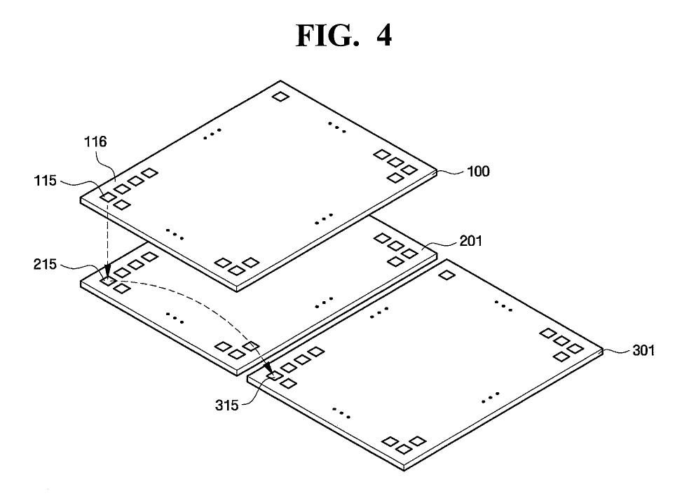

FIG. 4 is a schematic view illustrating a biochip according to another embodiment of the present invention.

Referring to FIG. 4, an optical sensor 201 and a memory cell array 301 are not stacked, unlike the above-described embodiment. In detail, the optical sensor 201 and the memory cell array 301 may be disposed on the same plane. For example, the optical sensor 201 and the memory cell array 301 may be formed on respective different substrates, and be separated from each other on the same plane.

Although not shown, an optical sensor and a memory cell array may also be formed on the same substrate by a single process. That is, an optical sensor (e.g., CIS) and a nonvolatile memory cell array (e.g., a flash memory cell array) may be formed on a single substrate by a CMOS process, and a probe cell array separately manufactured may be then formed above the optical sensor by a packaging process or the like.

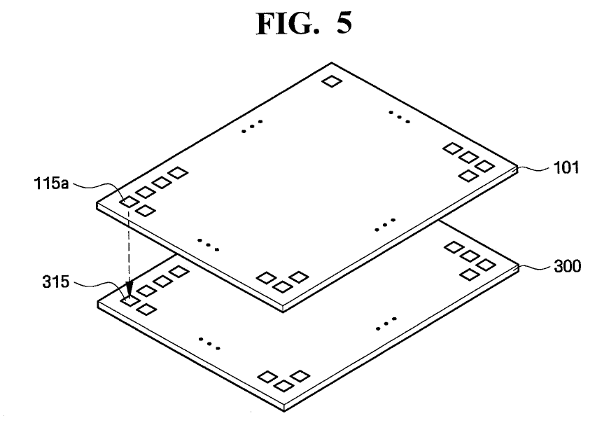

FIG. 5 is a schematic view illustrating a biochip according to still another embodiment of the present invention.

Referring to FIG. 5, biomolecule-probe hybridization is detected by electrical signals emitted from probe cells 115a, unlike the biochip illustrated in FIGS. 1 through 3 in which biomolecule-probe hybridization is detected by optical signals emitted from probe cells.

According to an embodiment of the present invention, the biochip includes a probe cell array 101 detecting electrical signals from probe cells 115a selectively coupled with biomolecules of a biological sample and a memory cell array 300 storing the electrical signals. The probe cell array 101 and the memory cell array 300 may be sequentially stacked, like the embodiment shown in FIGS. 1 through 3, and in particular, they may be formed on respective different substrates and stacked.

The electrical signals from the probe cells 115a may be signals that vary depending on changes in conductance of the probe cells 115a coupled with biomolecules, or signals that vary depending on changes in dielectric constant, etc. The probe cell array 101 supplying the electrical signals may be diversely structured according to the types of signals. For convenience of illustration, the probe cell array 101 will be described hereinafter in terms of a probe cell array disclosed in Korean Patent Application No. 10-2007-0094290, the contents of which are herein incorporated by reference in their entirety. However, it will be understood by one of ordinary skill in the art that the probe cell array 101 is not limited to the illustrated example.

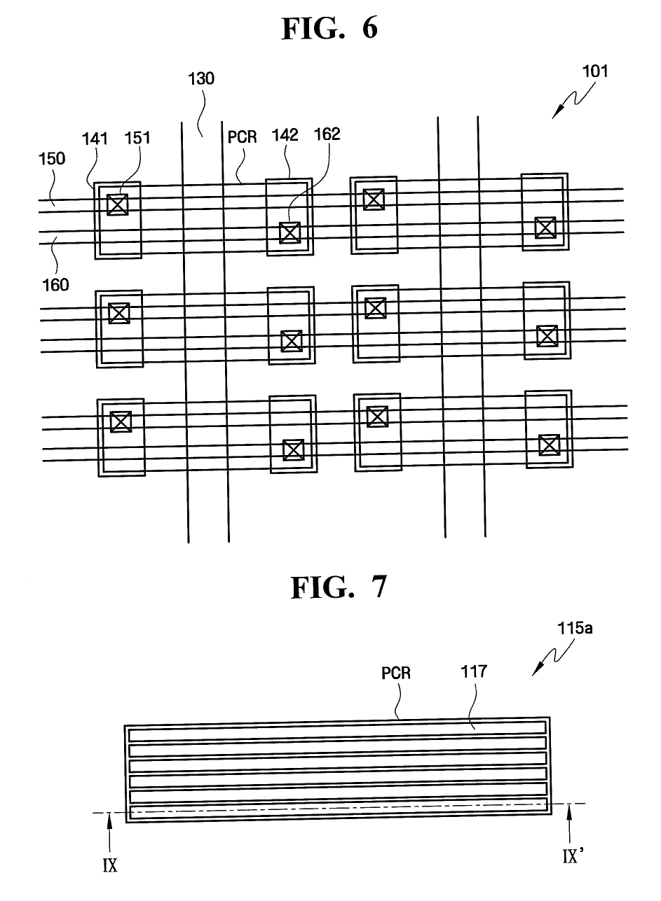

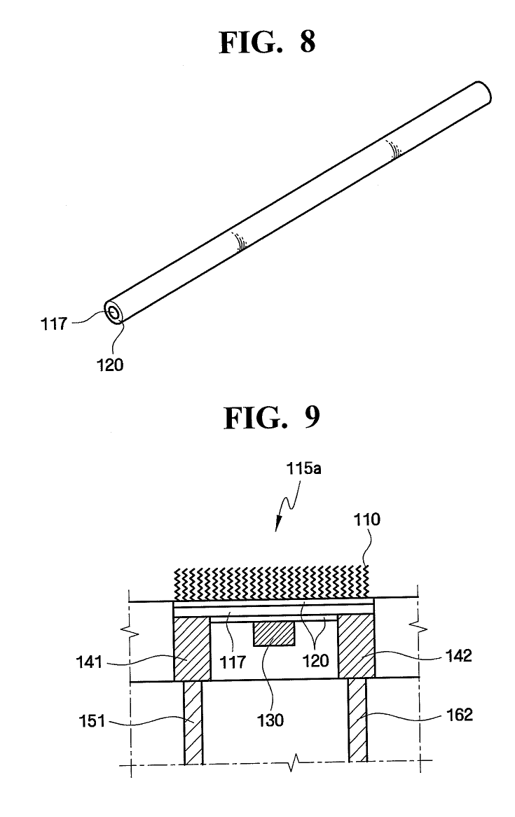

FIG. 6 is a layout illustrating a probe cell array of the biochip of FIG. 5, FIG. 7 is a front view illustrating a probe cell of the probe cell array of FIG. 6, FIG. 8 is a perspective view illustrating a semiconductor nanostructure of the probe cell of FIG. 7, and FIG. 9 is a sectional view taken along a line IX-IX′ of FIG. 7.

Referring to FIGS. 6 through 9, as well as FIG. 5, the probe cell array 101 includes probe cells 115a and first and second lines 150 and 160.

The probe cells 115a include a probe cell region PCR and at least one semiconductor nanostructure 117 in the probe cell region PCR. For example, the semiconductor nanostructure 117 may be formed of Si, ZnO, GaN, Ge, InAs, GaAs, C, or a combination thereof. The semiconductor nanostructure 117 may be a multilayered nanostructure including a core and at least one shell surrounding the core. The semiconductor nanostructure 117 may include at least one of nanowires, nanotubes, and nanoparticles. For convenience of illustration, the semiconductor nanostructure 117 may be described hereinafter in terms of a nanowire-shaped nanostructure.

A coating layer 120 may be formed on a surface of the semiconductor nanostructure 117, as illustrated in FIG. 8. The coating layer 120 may perform at least one of the following functions: providing stable protection of the semiconductor nanostructure 117, preventing electrical communication between adjacent semiconductor nanostructures in a direction other than a channel (i.e., semiconductor nanostructure) direction, functioning as an active layer for coupling with a linker and/or a probe, and functioning as a gate insulating layer. For example, the coating layer 120 may be formed of a silicon oxide such as PE-TEOS, HDP oxide, P—SiH₄ oxide, thermal oxide, native oxide, or pad oxide; a silicate such as hafnium silicate or zirconium silicate; a metal oxinitride such as silicon oxinitride, hafnium oxinitride, or zirconium oxinitride; a metal oxide such as titanium oxide, tantalum oxide, aluminum oxide, hafnium oxide, zirconium oxide, or ITO; or a polymer such as polystyrene, polyacrylic acid, or polyvinyl.

Probes 110 capable of selectively coupling with biomolecules of a biological sample are immobilized on the semiconductor nanostructure 117. For example, the probes 110 are coupled with electrically charged biomolecules, thereby causing a surface charge difference to be generated on the semiconductor nanostructure 117. Therefore, conductance may be changed in the semiconductor nanostructure 117 immobilized with the probes 110 which are selectively coupled with biomolecules. Biomolecule-probe hybridization can be detected by electrical signals generated by a change in conductance.

A first line 150 and a second line 160 are electrically connected to opposite ends of the semiconductor nanostructure 117, and a gate line 130 may be formed on the semiconductor nanostructure 117. That is, the semiconductor nanostructure 117, together with the gate line 130, the first line 150, and the second line 160, may form a transistor.

The gate line 130 serves to supply a threshold voltage to a channel, and thus, enables accurate detection of biomolecule-probe hybridization.

The first line 150 and the second line 160 may be disposed to extend in a predetermined direction. The first line 150 and the second line 160 may respectively serve as source and drain lines connected to the channel. The first line 150 may be electrically connected to a side of the semiconductor structure 117 via a first contact pad 141 and a first contact 151, and the second line 160 may be electrically connected to the other side of the semiconductor nanostructure 117 via a second contact pad 142 and a second contact 162. That is, the first line 150 and the second line 160 can transfer electrical signals generated by a conductance change in the semiconductor nanostructure 117 to an electrical signal detection circuit (not shown).

The memory cell array 300 stores electrical signals from probe cells 115a which are selectively coupled with biomolecules in the probe cell array 101. That is, electrical signals generated according to biomolecule-probe hybridization in the probe cell array 101 can be stored in the memory cell array 300.

Therefore, according to an embodiment of the present invention, it is possible to more stably detect biomolecule-probe hybridization, which is described in more detail. Once biomolecule-probe hybridization occurs, electrical signals generated after the hybridization may be generally attenuated over time under the conditions in which a biochip is placed. However, according to an embodiment of the present invention, since biomolecule-probe hybridization results are stored in a memory cell array immediately after the hybridization, the hybridization results can be analyzed more stably.

Moreover, according to an embodiment of the present invention, since detection of biomolecule-probe hybridization and storage of the hybridization results are performed in a single chip, it is possible to more efficiently detect biomolecules in a biological sample and to analyze the detection results.

Although not shown, a probe cell array and a memory cell array may be formed on the same substrate or respective different substrates, and be separated from each other on the same plane.

While embodiments of the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A biochip comprising:
a probe cell array comprising a plurality of probe cells capable of coupling with biomolecules of a biological sample;
an optical sensor adapted to detecting optical signals from probe cells selectively coupling with the biomolecules of the biological sample and converting the optical signals to digital electrical signals; and
a memory cell array adapted to storing the digital electrical signals.

2. The biochip of claim 1, wherein the probe cell array is stacked on the optical sensor, the probe cell array is formed on a first substrate, and the optical sensor is formed on a second substrate.

3. The biochip of claim 2, wherein the optical sensor is stacked on the memory cell array, and the memory cell array is formed on a third substrate.

4. The biochip of claim 3, wherein the optical sensor and the memory cell array are formed on the same substrate and are separated from each other in a plane.

5. The biochip of claim 2, wherein the first substrate is a light-transmissible substrate.

6. The biochip of claim 1, wherein the optical sensor is disposed to correspond to each of the probe cells, and wherein the optical sensor comprises:
an optical sensor pixel array comprising a plurality of optical sensor pixels converting the optical signals to analog electrical signals; and
an analog-to-digital converter converting the analog electrical signals to the digital electrical signals.

7. The biochip of claim 6, wherein the optical sensor comprises a plurality of analog-to-digital converters, and the analog-to-digital converters are disposed to correspond to the optical sensor pixels.

8. The biochip of claim 1, wherein the optical sensor is a CMOS image sensor (CIS).

9. The biochip of claim 1, wherein the memory cell array is a nonvolatile memory cell array.

10. A biochip comprising:
a probe cell array comprising a plurality of probe cells capable of coupling with biomolecules of a biological sample and detecting electrical signals from probe cells selectively coupling with the biomolecules of the biological sample; and
a memory cell array adapted to storing the electrical signals.

11. The biochip of claim 10, wherein the probe cell array is stacked on the memory cell array, and the probe cell array and the memory cell array are formed on respective different substrates.

12. The biochip of claim 10, wherein the probe cell array and the memory cell array are formed on the same substrate and are separated from each other in a plane.

13. The biochip of claim 10, wherein the memory cell array is a nonvolatile memory cell array.

14. The biochip of claim 10, wherein the electrical signals are signals that are generated according to a change in conductance of the probe cells coupling with the biomolecules of the biological sample.

15. The biochip of claim 10, wherein each of the probe cells comprises:
a semiconductor nanostructure; and
a plurality of probes immobilized on the semiconductor nanostructure.

16. The biochip of claim 15, wherein the semiconductor nanostructure is at least one selected from the group comprising nanowires, nanotubes, and nanoparticles.

17. The biochip of claim 15, wherein the semiconductor nanostructure comprises at least one selected from the group comprising Si, ZnO, GaN, Ge, InAs, GaAs and C.
